(19) United States
(12) Patent Application Publication
(10) Pub. No.: US 2002/0172115 A1
(43) Pub. Date: Nov. 21, 2002

(54) Disk drive device

(75) Inventor: Akira Tsukihashi, Ohra-gun (JP)

Correspondence Address: HOGAN & HARTSON L.L.P., 500 S. GRAND AVENUE, SUITE 1900, LOS ANGELES, CA, 90071-2611, US

(73) Assignee: SANYO ELECTRIC CO., LTD.

(21) Appl. No.: 10/151,051

(22) Filed: May 17, 2002

(30) Foreign Application Priority Data
May 18, 2001 (JP) 2001-149412

(51) Int. Cl. G11B 7/00

(52) U.S. Cl. 369/53.18; 369/53.37

(57) ABSTRACT

A mode setting circuit (13) establishes a maximum speed enabling mode when an external power source connection detecting circuit (12) detects connection of an external power source and establishes a maximum speed restricting mode when the external power source connection detecting circuit (12) does not detect connection of an external power source. Data processing at the maximum disk rotation speed is enabled when the external power source is connected and, when no external power source is connected, the disk rotation speed is restricted to a speed corresponding to a data transfer rate at which power required for the data processing can be supplied from an interface (1).

### BACKGROUND OF THE INVENTION

1. Field of the Invention

The present invention relates to a disk drive device to which power can be supplied from an interface and an external power source, and relates, for example, to a disk drive device suitable for a device with a USB (Universal Serial Bus) interface.

2. Description of Related Art

CD-R (Recordable) drives and CD-RW (Rewritable) drives of the CD family, which are disk drive devices capable of recording, have been widely introduced as removable storage devices for a personal computers.

In these disk drive devices, attempts have been made to increase the rotation speed of a disk. For recording, CD-Rs are currently capable of high speed recording at 16 or more times the standard speed, and CD-RWs are capable of high speed recording at 8 or 10 times the standard speed.

The USB (Universal Serial Bus) standard is a known interface standard for connecting peripherals to a personal computer. USB interfaces are provided with a power supply line, and many of the stand-alone type disk drive devices adopt such USB interfaces.

The current USB standard is USB 2.0, but USB 1.1, the previous standard, remains supported.

The USB 2.0 standard allows data transfer at 480 Mbps, while the USB 1.1 standard allows data transfer at a rate of up to 12 Mbps. Accordingly, with USB 1.1, data transfer is limited to a speed up to approximately 6 times the rated rotation speed of a disk. With USB 2.0, on the other hand, the disk rotation speed is not practically restricted by the data transfer rate.

In order to increase the data transfer rate of disk drive devices, not only the disk rotation speed, but also the processing speed of a data processor, a response of a servo circuit, and an access speed must be increased. Consequently, when the data transfer rate is increased, power consumption in substantially all circuits, including a disk servo circuit, a data processing circuit, a laser drive circuit, and a head servo circuit of an optical head, also increases.

Accordingly, there is a problem that under current conditions, even for a disk drive device compatible with USB 2.0, sufficient power cannot be supplied to the drive device through the USB interface, and thus attempts to increase the speed of the disk drive device are restricted by the power supply ability of the USB interface.

Therefore, in order to achieve high speed operation of the disk drive device, external power supply through an AC adaptor or the like is required. In other words, high speed disk drive devices can only be achieved when power is supplied from an external power source.

However, it is also necessary to consider the possibility that use of an external power source may not be appropriate in situations where power supply from the external power source is not possible or where use of a cable for connection to the external power source is undesirable, such as when the cable would be unsightly or on obstruction.

### SUMMARY OF THE INVENTION

The present invention was conceived in view of the problems of the related art described above and aims to provide a disk drive device capable of achieving both high speed data transfer and suppressed power consumption when an external power source is not used.

According to the present invention, when an external power source is connected, data processing at the maximum disk rotation speed is enabled. When the external power source is not connected, on the other hand, the maximum disk rotation speed is restricted to a speed corresponding to a data transfer speed at which power sufficient for the requirements of the data processing can be supplied through the interface.

### BRIEF DESCRIPTION OF THE DRAWINGS

These and other objects of the invention will be explained in the description below, in connection with the accompanying drawings, in which:

FIG. 1 is a diagram showing a structure of a disk drive device according to one embodiment of the present invention; and

FIG. 2 is a flow chart for explaining a mode setting operation in the disk drive device shown in FIG. 1.

### DETAILED DESCRIPTION OF THE PREFERRED EMBODIMENT

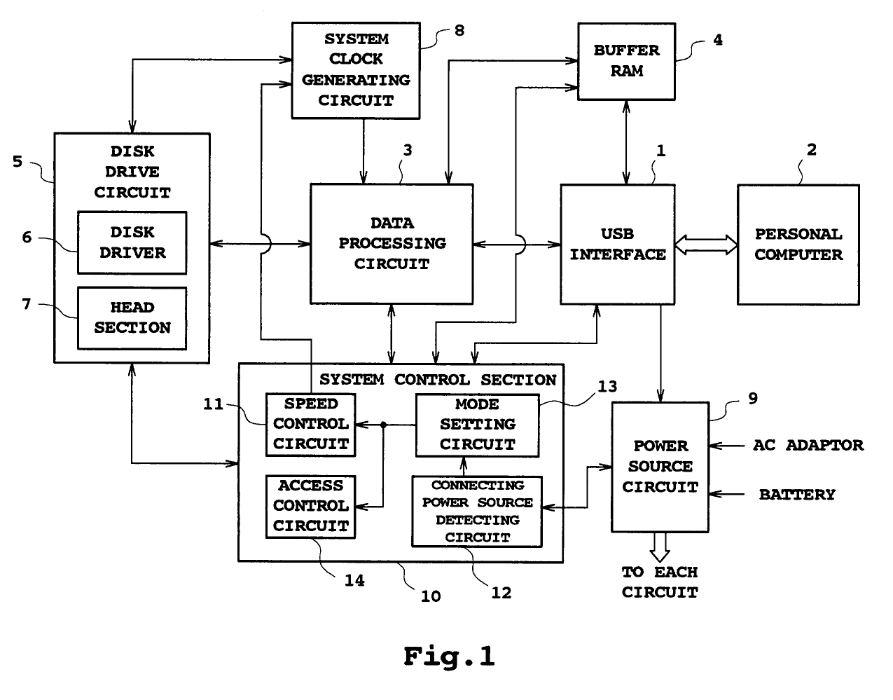

FIG. 1 illustrates a structure of a disk drive device according to one embodiment of the present invention.

Referring to FIG. 1, a USB interface 1 controls data reception and transmission to and from a personal computer 2 which serves as a host device. A data processing circuit 3 encodes data supplied from the personal computer 2 to create recording data in the form suitable for recording onto a disk. The data processing circuit 3 also decodes the recording data which is read from the disk. Data input and output through the interface 1 is stored in the buffer RAM 4 which is also used in data processing by means of the data processing circuit 3. A disk drive section 5 includes a disk driver 6 for driving a disk and a head section 7 for driving and controlling an optical head which performs data write and read to and from the disk. An operation clock corresponding to the data transfer rate is supplied by a system clock generation circuit 8 to each circuit. Power is supplied from the AC adaptor, a battery, and the interface 1 to a power source circuit 9, which then generates and supplies various output power to various circuits. A system control circuit 10 performs general control of the system regarding data recording and reproduction.

The system control circuit 10 includes a speed control circuit 11 for controlling the disk driver 6 to control the rotation speed of the disk, making the various operation clocks generated from the system clock generating circuit 8 correspond to the disk rotation speed, and controlling the various circuits including the data processing circuit 3 and the interface 1 to operate such that data processing is performed at a data transfer rate in accordance with the disk rotation speed; a connecting power source detecting circuit 12 for detecting the connection of the external power source of the AC adaptor; a mode setting circuit 13 for selectively setting, in accordance with the detection output from the connecting power source detecting circuit 12, a maximum speed enabling mode in which the maximum rotation speed of the disk that can be achieved by the personal computer is not restricted or a maximum speed restricting mode in which the maximum disk rotation speed is restricted; and an access control circuit 14 which controls the head section 7 to control an access operation.

It is preferable that the system control circuit 10 is constituted by a microcomputer. It is therefore preferable that various signals to be input to the system control circuit 10 are in a digital data form. However, when an analog signal is to be input, the analog signal can be converted into digital data using an A/D converter before subsequent processing. Further, when the system control circuit 10 is implemented by a microcomputer, the speed control circuit 11, the connecting power source detection circuit 12, the mode setting circuit 13, and the access control circuit 14 are implemented as functions of the microcomputer. Alternatively, the system control circuit 10 may be constituted by hardware.

In the disk drive device having the above structure, when a command requesting data write onto the disk is input from the personal computer 2 to the system control circuit 10 via the interface 1, the system control circuit 10 controls each of the various circuits and mechanisms so that each enters a recording condition for performing data recording onto a disk.

In this recording condition, file data corresponding to the writing request is transmitted from the personal computer 2 via the interface 1 and is then written in the buffer RAM 4. The data is then supplied to the data processing circuit 3 where an error detection code and an error correction code are added to the data, the resultant data is subjected to a modulation process in accordance with a disk medium (CD), a synchronization signal is further added to the modulated data, and the processed data is then encoded into recording data in a form suitable for recording onto the disk. The recording data thus processed is sequentially supplied to the disk drive section 5 and is then written onto the disk via the head section 7.

On the other hand, when a command requesting data read is input from the personal computer 2 to the system control circuit 10 via the interface 1, the system control circuit 10 controls each of the various circuits and mechanisms so that each enters a reproduction condition for reproducing data stored on a disk.

In this reproduction condition, a signal corresponding to the data which is requested to be read is read from the disk by means of the optical head of the head section 7. The signal thus read is then supplied to the data processing circuit 3 where a demodulation process in accordance with a disk medium is performed so that the data is separated into various signals. The data in the various signals is then subjected to error detection and error correction, is stored in the buffer RAM 4 as necessary, and is then transmitted to the personal computer 2 via the interface 1.

The disk drive device according to the present invention is capable of high speed recording and high speed reproduction. Specifically, reproduction at a high speed corresponding to the data transfer rate which is up to several tens times faster, e.g., 40 times faster, than the rated rotation speed of a disk can be performed. For CD-R, recording at a high speed corresponding to the data transfer rate which is, for example, 20 times that of the rated rotation speed of a disk can be performed, and for CD-RW recording at a high speed corresponding to the data transfer rate which is, for example, 10 times that of the rated rotation speed of a disk can be performed.

Further, the USB interface 1 in the disk drive device corresponds to USB 2.0. Therefore, the interface 1 permits a sufficiently high data transfer rate, which will not restrict the disk rotation speed for high speed recording and high speed reproduction.

However, when an AC adaptor is not connected, the disk rotation speed for high speed recording and high speed reproduction is restricted because of power consumption requirements.

Accordingly, the disk drive device shown in FIG. 1 is provided with the mode setting circuit 13 to select a mode for setting the maximum rotation speed of a disk for high speed recording and high speed reproduction in accordance with the detection output from the connecting power source detecting circuit 12.

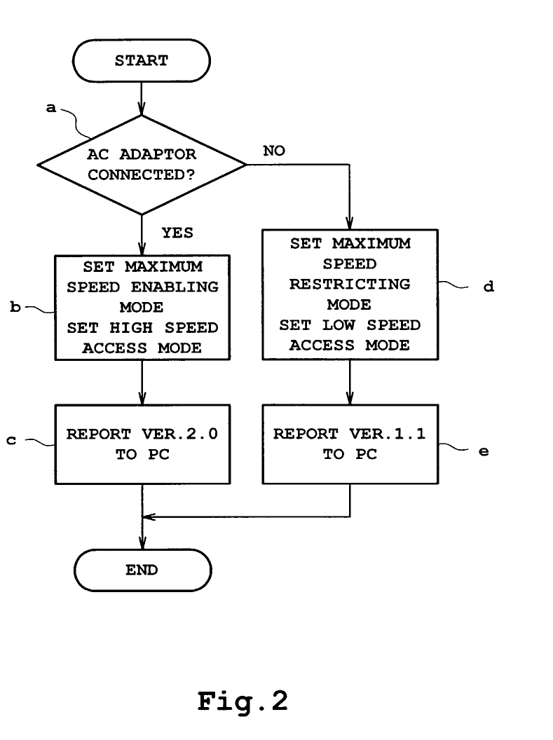

In this mode setting, operations are performed based on the flow chart shown in FIG. 2. The mode setting operations will be described with reference to FIG. 2.

After the power source of the disk drive device is turned on or the disk drive device is reset, during the startup operation of the disk drive device, the connecting power source detecting circuit 12 detects the connection state of the power source circuit 9 to determine whether or not an AC adaptor is connected to the power source circuit 9 (step a).

When it is determined that an AC adaptor is connected, the mode setting circuit 13 establishes a maximum speed enabling mode in which setting of the maximum speed is not restricted, and simultaneously establishes a high speed access mode for the access control to be performed by the access control circuit 14 which permits high speed access corresponding to the maximum speed enabling mode (step b). In other words, high speed access which conforms to the maximum speed enabling mode is enabled for data recording onto a disk and data reading from the disk by means of the head section 7.

Also, when an AC adaptor is connected, the fact that the disk drive device adopts the USB 2.0 standard is reported to the personal computer 2 (step c). Thus, the personal computer 2 recognizes that the disk drive device connected thereto is USB 2.0 compatible.

Consequently, the personal computer 2 operates based on the version of USB adopted, so that data recording and data reproduction can be set at any speed enabled by the disk drive device without restricting the maximum disk rotation speed for high speed recording and high speed reproduction which can be achieved by the personal computer 2.

In this manner, the disk drive device becomes capable of performing data recording and data reproduction at any enabled speed without restriction of the maximum disk rotation speed.

Here, in the high speed access control mode, it is possible to perform high speed thread transfer to achieve the maximum access performance.

Further, the personal computer is ready to issue a command corresponding to USB 2.0

On the other hand, at step a, if it is determined that an AC adaptor is not connected, the mode setting circuit 13 establishes the maximum speed restricting mode in which the maximum speed which can be set is restricted. Simultaneously, the access control circuit 14 sets low speed access control mode which conforms with the established maximum speed restricting mode (step d).

Further, when an AC adaptor is not connected, the fact that the USB 1.1 standard is adopted is reported to the personal computer 2 (step e). Consequently, the personal computer 2 recognizes that the disk drive device connected thereto is compatible with USB 1.1.

Consequently, the personal computer 2 operates based on the version of USB adopted, so that the maximum disk rotation speed for high speed recording and high speed reproduction by the personal computer 2 is restricted to a speed which is no more than 6 times that of the rated speed, corresponding to the data transfer rate of USB 1.1. In other words, the disk drive device is now capable of data recording and reproduction only at a speed no more than the 6× speed.

In this manner, the disk drive device becomes capable of performing data recording and data reproduction at the maximum disk rotation speed restricted to a speed which is no more than 6 times that of the rated rotation speed.

Further, the personal computer 2 is prepared to issue a command corresponding to USB 1.1.

As a result, power requirements of the disk drive device can be reduced so that the power from the interface or the battery can be sufficient.

In such case, the access control is performed at a thread transfer rate which conforms to the 6× speed, which puts reduction in power consumption before performance.

As described above, according to the above embodiment, when an external power source is connected to the disk drive device, data processing at the maximum disk rotation speed is enabled to thereby permit the maximum performance for high speed recording and high speed reproduction. When an external power source is not connected, the maximum disk rotation speed is restricted such that data processing can be performed by a power supply from the interface, thereby achieving both high speed data transfer and reduced power consumption.

While the preferred embodiment of the present invention has been described using specific terms, such description is for illustrative purposes only, and it is to be understood that changes and variations may be made without departing from the spirit or scope of the appended claims.

What is claimed is:

1. A disk drive device which is connected to a host device via an interface capable of supplying power and which can be supplied with power from either said interface or an external power source, said disk drive device comprising:
a speed control circuit for controlling the rotation speed of a disk to be installed;
an external power source connection detecting circuit for detecting connection of said external power source; and
a mode setting circuit for selectively establishing, in accordance with a detection output from the external power source connection detecting circuit, a maximum speed enabling mode in which the maximum disk rotation speed requestable by said host device is not restricted and a maximum speed restricting mode in which said maximum disk rotation speed is restricted,
wherein said mode setting circuit establishes the maximum speed enabling mode when said external power source connection detecting circuit detects the connection of the external power source and establishes the maximum speed restricting mode when said external power source connection detecting circuit does not detect the connection of the external power source.

2. A disk drive device according to claim 1, wherein said interface is a USB (Universal Serial Bus) interface, provides a lower version compatibility enabling a lower communication speed and an upper version compatibility enabling a higher communication speed, and reports to said host device that the interface can adopt the upper version when said external power source connection detecting circuit detects the connection of an external power source and reports that the interface can adopt the lower version when said external power source connection detecting circuit does not detect the connection of an external power source.

3. A disk drive device according to claim 1, wherein said speed control circuit controls the data transfer rate of said interface to a speed corresponding to the rotation speed of the disk.

4. A disk drive device according to claim 1, further comprising an access control circuit for controlling access to said disk,
wherein said access control circuit controls an access speed based on a mode established by said mode setting circuit.

5. A disk drive device according to claim 1, further comprising a system clock generating circuit for generating a system clock,
wherein said speed control circuit controls the rotation speed of the disk by changing a system clock generated in said system clock generating circuit.

6. A disk drive device according to claim 5, further comprising a data processing circuit for processing data to be written onto the disk and data read from the disk,
wherein said disk drive device operates based on a system clock generated in said system clock generating circuit.
